(19) United States
(12) Patent Application Publication
(10) Pub. No.: US 2011/0125995 A1
(43) Pub. Date: May 26, 2011

(54) METHOD AND APPARATUS FOR DOWNLOADING SECURE MICRO BOOTLOADER OF RECEIVER IN DOWNLOADABLE CONDITIONAL ACCESS SYSTEM

(75) Inventors: Myung Sik CHOI, Suwon-si (KR); Yong Gi LEE, Suwon-si (KR)

(73) Assignee: SAMSUNG ELECTRONICS CO. LTD., Suwon-si (KR)

(21) Appl. No.: 12/954,732

(22) Filed: Nov. 26, 2010

(30) Foreign Application Priority Data
Nov. 26, 2009 (KR) 10-2009-0115251

(51) Int. Cl. G06F 9/24

(52) U.S. Cl. 713/2

(57) ABSTRACT

A method and apparatus for downloading a Secure Micro (SM) bootloader of a receiver in a Downloadable Conditional Access System (DCAS) is provided. The method includes generating, by a transmitter, an SM bootloader for the receiver and adding the generated SM bootloader to firmware to be transferred to the receiver, sending, by the transmitter, the firmware to the receiver, and performing, by the receiver, registration by receiving the firmware, locating an SM bootloader in the firmware, and registering the located SM bootloader. In the DCAS, a receiver may download or install an SM bootloader through an online or offline procedure.

### PRIORITY

This application claims the benefit under 35 U.S.C. §119(a) of a Korean patent application filed on Nov. 26, 2009 in the Korean Intellectual Property Office and assigned Serial No. 10-2009-0115251, the entire disclosure of which is hereby incorporated by reference.

### BACKGROUND OF THE INVENTION

1. Field of the Invention

The present invention relates to a communication system. More particularly, the present invention relates to a method and apparatus for downloading a Secure Micro (SM) bootloader of a receiver for a Downloadable Conditional Access System (DCAS) in a digital broadcast network.

2. Description of the Related Art

A Conditional Access (CA) system refers to an access control system that allows only legitimate subscribers to view broadcast content in a broadcast content providing system such as a cable television system.

In an existing CA System (CAS), CA software (or CA client image) stored in a smart card or a Personal Computer Memory Card International Association (PCMCIA) card is distributed off-line. A defect occurring in the CAS may require card replacement. However, card replacement is both time consuming and costly, making it difficult to rapidly address problems.

To overcome this problem, a Downloadable Conditional Access System (DCAS) based on a two-way cable communication network have been developed. A digital broadcast receiver in the DCAS includes a Secure Micro (SM), which functions as a security module to allow only a legitimate subscriber to view a broadcast, and a SM bootloader for monitoring an operation of the SM.

In an existing DCAS, as the SM bootloader is embedded in a nonvolatile memory or SM chip of a digital broadcast receiver during a manufacturing process, it is difficult to update or download the SM bootloader online or offline. Even in a case of an offline update, the installer must connect a removable storage medium such as a Universal Serial Bus (USB) flash drive to a digital broadcast receiver, and locate and directly copy the SM bootloader.

In the related art, embedding of an SM bootloader within a digital broadcast receiver may lower manufacturability of the digital broadcast receiver. The SM bootloader embedded in a digital broadcast receiver may be exposed to various risks such as hacking, forgery, falsification, and the like. In addition, to fix a bug in the SM bootloader or to add a new function to the SM bootloader, many digital broadcast receivers may have to be recalled for individual update of the SM bootloader.

Therefore, a need exists for a method and apparatus for updating and downloading a SM bootloader online and offline.

### SUMMARY OF THE INVENTION

An aspect of the present invention is to address at least the above mentioned problems and/or disadvantages and to provide at least the advantages described below. Accordingly, an aspect of the present invention is to provide a method and apparatus that enable a digital broadcast receiver in a Downloadable Conditional Access System (DCAS) to register a Secure Micro (SM) bootloader online or offline.

Another aspect of the present invention is to provide a method and apparatus for securely downloading an SM bootloader wherein encryption and a digital signature are used to prevent hacking, forgery, falsification and the like in transmission of firmware containing the SM bootloader.

In accordance with an aspect of the present invention, a method for downloading a Secure Micro (SM) bootloader for a receiver in a Downloadable Conditional Access System (DCAS) is provided. The method includes generating, by a transmitter, an SM bootloader for the receiver and adding the generated SM bootloader to firmware to be transferred to the receiver, transmitting, by the transmitter, the firmware to the receiver, and performing, by the receiver, registration by receiving the firmware, locating an SM bootloader in the firmware, and registering the located SM bootloader.

In accordance with an aspect of the present invention, an apparatus for downloading an SM bootloader for a receiver from a transmitter in a DCAS is provided. The apparatus includes a wireless communication unit for receiving firmware from the transmitter, a control unit for determining presence of an SM bootloader in the received firmware and for registering, when an SM bootloader is located, the located SM bootloader, and a storage unit for storing the registered SM bootloader.

In an exemplary embodiment of the present invention, a digital broadcast receiver in a DCAS does not have to embed an SM bootloader in the manufacturing process because it can register an SM bootloader online or offline. Hence, it is possible to simplify manufacture of a digital broadcast receiver and to resolve inconvenience associated with a manual update of an SM bootloader. Further, it is possible to download an SM bootloader without modification of an existing digital broadcast headend system, and to protect the SM bootloader from hacking, forgery, falsification, and the like.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 depicts an initial installation and update of a Secure Micro (SM) bootloader in a digital broadcast receiver of a Downloadable Conditional Access System (DCAS) according to the related art;

FIG. 2 is a sequence diagram illustrating a procedure for a digital broadcast receiver to download an SM bootloader from a digital broadcast transmitter and install the same according to an exemplary embodiment of the present invention;

FIG. 3 is a block diagram of a digital broadcast transmitter generating and transmitting an SM bootloader according to an exemplary embodiment of the present invention;

FIG. 4 is a block diagram of a digital broadcast receiver according to an exemplary embodiment of the present invention;

FIG. 5 illustrates a structure of firmware containing an SM bootloader generated by an SM bootloader producer according to an exemplary embodiment of the present invention;

FIG. 6 is a flowchart illustrating a procedure performed by a digital broadcast transmitter according to an exemplary embodiment of the present invention;

FIG. 7 is a flowchart illustrating a procedure performed by a digital broadcast receiver according to an exemplary embodiment of the present invention;

FIG. 8 depicts an online procedure for a digital broadcast receiver to download an SM bootloader from a digital broadcast transmitter and to register the same according to an exemplary embodiment of the present invention; and

FIG. 9 depicts an offline procedure for a digital broadcast receiver to download and register an SM bootloader according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Exemplary embodiments of the present invention provide a Downloadable Conditional Access System (DCAS) that refers to a system that may provide data to user terminals on a subscription basis, and may include a digital broadcast transmitter (i.e., a DCAS headend) and a digital broadcast receiver (i.e., a DCAS host).

The digital broadcast transmitter may distribute, update and delete Conditional Access System (CAS) information related to fee-based broadcast data or subscription-based data. Here, the CAS information may include information regarding passwords and usage rights set for the fee-based data, and information on a Secure Micro (SM) and a CAS client. A cable broadcast station such as a system operator may be an example of the digital broadcast transmitter.

A digital broadcast receiver may be connected to a digital broadcast transmitter through a gateway connected to a DCAS network, and may process received data and provide the same to a user terminal. For example, the digital broadcast receiver may be a set-top box.

The SM is a security block of the DCAS that allows only a legitimate subscriber to view a broadcast. The SM may create a DCAS message and store and process security-related information.

The SM bootloader is a functional block for monitoring a process of downloading, updating and removing the SM. The SM bootloader may invoke a device driver and program necessary for normal operation of a digital broadcast receiver.

SM bootloader registration may indicate initial installation of an SM bootloader or update of an existing SM bootloader.

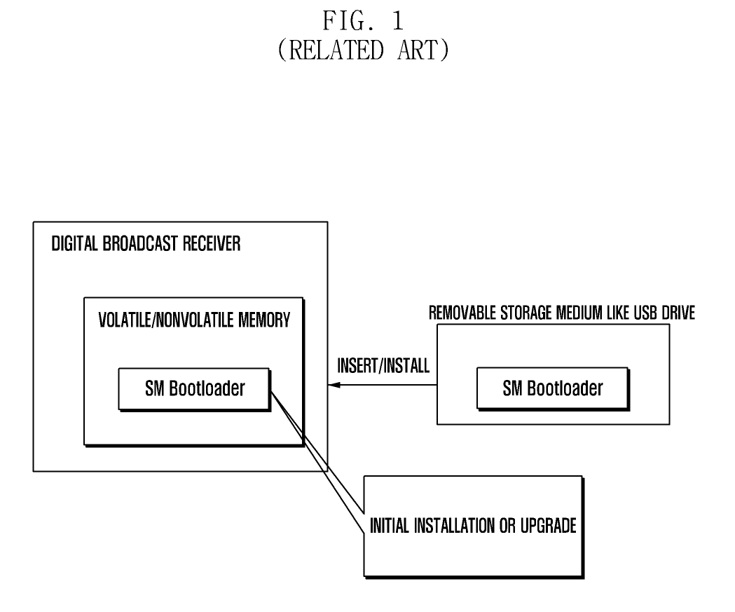

FIG. 1 depicts initial installation and update of an SM bootloader in a digital broadcast receiver of a DCAS according to the related art.

Referring to FIG. 1, in the existing DCAS, the SM bootloader is stored in a volatile or nonvolatile memory or SM chip of a digital broadcast receiver during a manufacturing process. Hence, it is not possible to update or download the SM bootloader online. The DCAS specification does not specify a mechanism for updating or downloading the SM bootloader online.

In FIG. 1, to install an SM bootloader, the installer connects a removable storage medium to the digital broadcast receiver, and locates the SM bootloader in a removable storage medium and copies the same to the digital broadcast receiver.

The exemplary embodiments of the present invention address inconveniences in installing an SM bootloader in a digital broadcast receiver of the DCAS. That is, a scheme is provided that enables a digital broadcast receiver to download an SM bootloader from a broadcast network and register the SM bootloader.

A description is given of a method that enables a digital broadcast receiver to download an SM bootloader through a broadcast network and register the SM bootloader online. However, the present invention is not limited to this. That is, the digital broadcast receiver may also download an SM bootloader from a removable storage medium and install the SM bootloader offline.

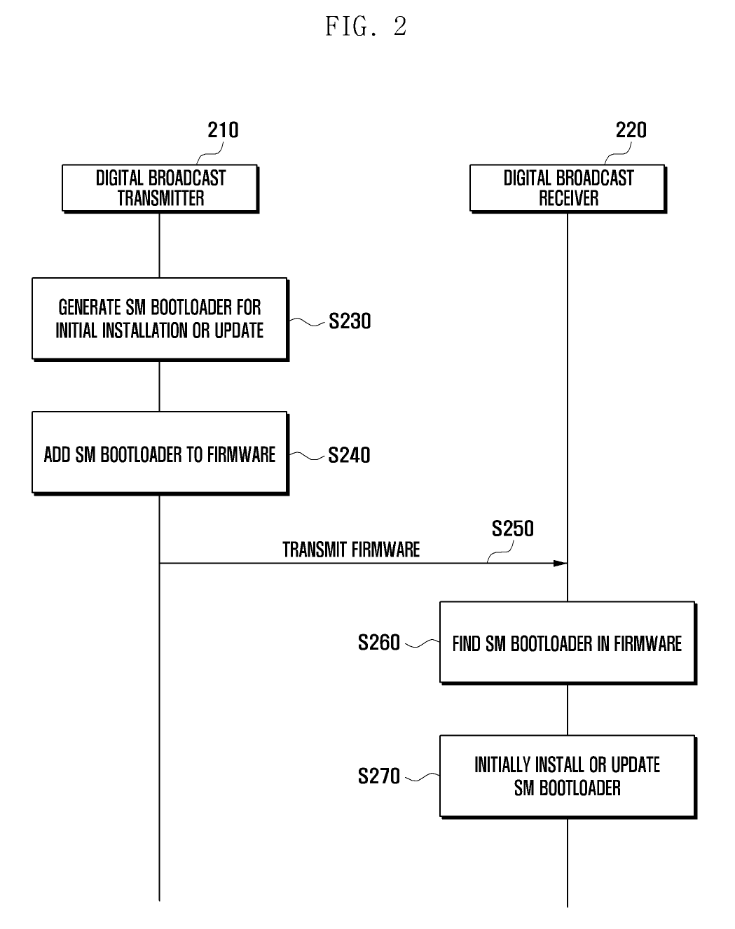

FIG. 2 is a sequence diagram illustrating a procedure for a digital broadcast receiver to download an SM bootloader from a digital broadcast transmitter and to install the same according to an exemplary embodiment of the present invention.

Referring to FIG. 2, an SM bootloader may be embedded in the digital broadcast receiver 220 during a manufacturing process. The digital broadcast receiver 220 may download an SM bootloader from the digital broadcast transmitter 210 and install the downloaded SM bootloader at initial startup. When it is necessary to update the installed SM bootloader, the digital broadcast receiver 220 may connect to the digital broadcast transmitter 210 and download a new SM bootloader.

The digital broadcast transmitter 210 generates an SM bootloader for initial installation or update in step S230. The digital broadcast transmitter 210 adds the generated SM bootloader to firmware that is to be transmitted to the digital broadcast receiver 220 in step S240. In an exemplary embodiment of the present invention, the SM bootloader is registered through the firmware of the digital broadcast receiver 220. The digital broadcast transmitter 210 transmits the firmware containing the SM bootloader to the digital broadcast receiver 220 in step S250.

Upon reception of the firmware from the digital broadcast transmitter 210, the digital broadcast receiver 220 locates an SM bootloader in the received firmware in step S260. The digital broadcast receiver 220 initially installs the received SM bootloader or replaces the existing SM bootloader with the received SM bootloader in step S270.

As described above, the digital broadcast receiver 220 may initially install an SM bootloader or update an existing SM bootloader online.

FIG. 3 is a block diagram of a digital broadcast transmitter generating and transmitting an SM bootloader according to an exemplary embodiment of the present invention.

Referring to FIG. 3, the digital broadcast transmitter 210 may include an SM bootloader producer 310, a control unit 320, and a wireless communication unit 330.

The SM bootloader producer 310 generates an SM bootloader to be registered in the digital broadcast receiver 220. The SM bootloader producer 310 adds the generated SM bootloader to firmware for the digital broadcast receiver 220. More particularly, the SM bootloader producer 310 may attach an electronic signature to the generated SM bootloader to prevent hacking, forgery, falsification, and the like of the SM bootloader. For data security, the SM bootloader producer 310 may encrypt the data zone of the firmware. Here, encryption may be performed using various encryption algorithms such as a Data Encryption Standard (DES) and SEED. The structure of the firmware is described below.

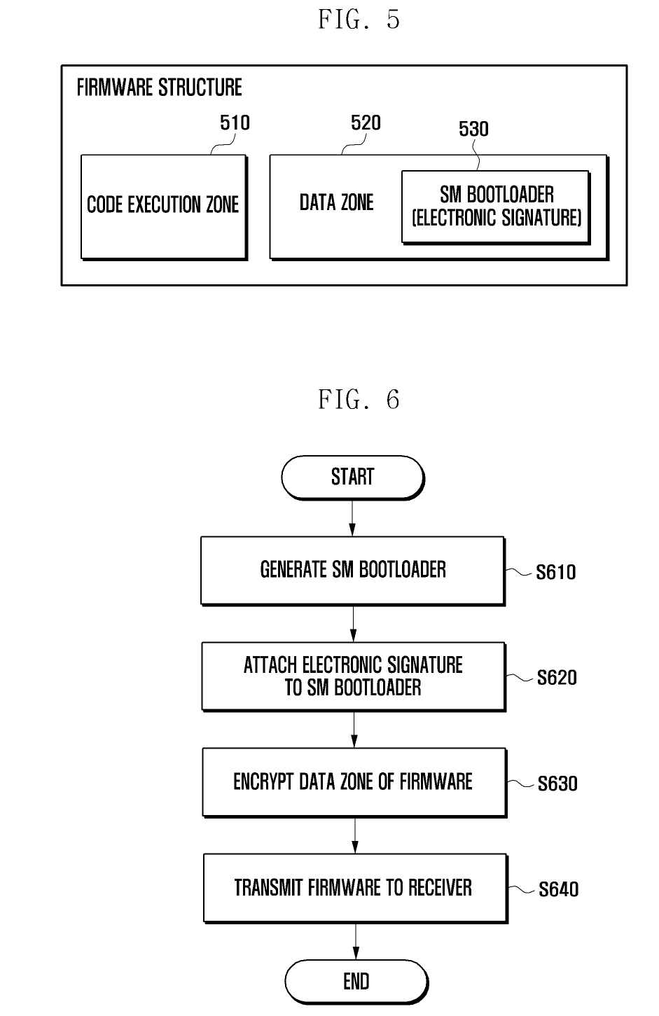

FIG. 5 illustrates a structure of a firmware generated by an SM bootloader producer according to an exemplary embodiment of the present invention.

Referring to FIG. 5, the firmware includes a code execution zone 510 and a data zone 520. The SM bootloader producer 310 stores an SM bootloader 530 in a region of the data zone 520. To ensure integrity of the SM bootloader 530, the SM bootloader producer 310 may attach an electronic signature thereto.

The SM bootloader producer 310 stores a firmware file in the remainder of the data zone 520 for firmware update of the digital broadcast receiver 220. Hence, upon reception of the firmware, the digital broadcast receiver 220 may simultaneously perform SM bootloader and firmware installation.

Referring back to FIG. 3, the control unit 320 controls an overall operation of the digital broadcast transmitter 210. When the digital broadcast transmitter 210 functions as a DCAS headend, the control unit 320 may scramble programs and data so that only legitimate subscribers may view broadcast content, and perform authentication and access control to protect broadcast content on communication links. More particularly, the control unit 320 controls the wireless communication unit 330 to transmit the firmware created by the SM bootloader producer 310 to the digital broadcast receiver 220.

The wireless communication unit 330 transmits firmware containing an SM bootloader to the digital broadcast receiver 220 under the control of the control unit 320. When the wireless communication unit 330 uses radio frequency communication, it may include a radio frequency transmitter for upconverting the frequency of a signal to be transmitted and amplifying the signal, and a radio frequency receiver for low-noise amplifying a received signal and downconverting the frequency of the received signal.

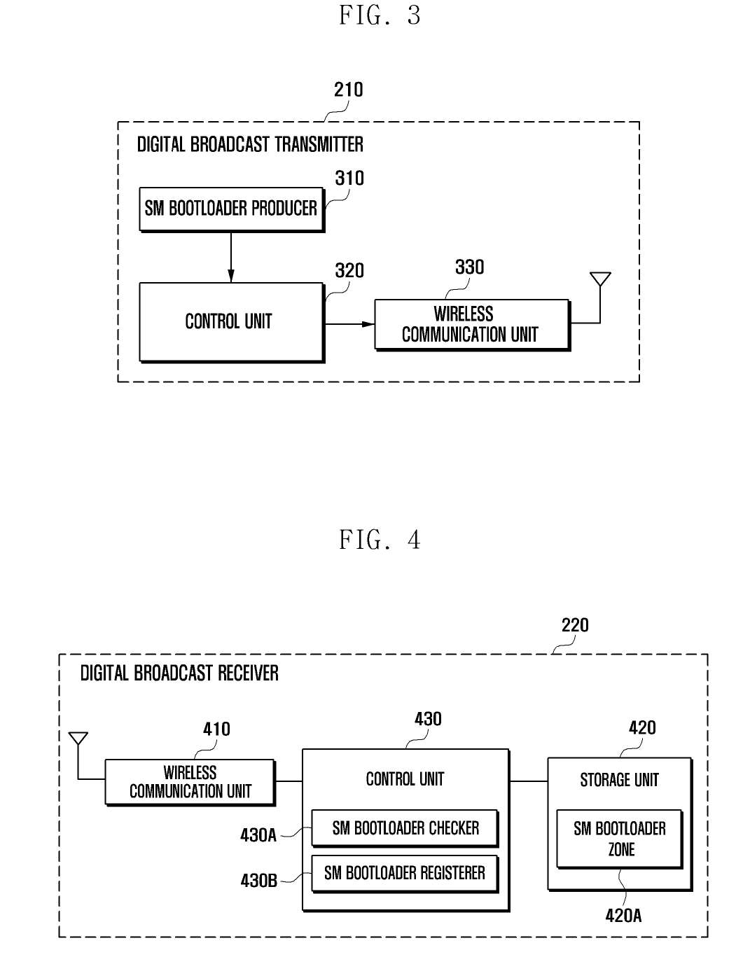

FIG. 4 is a block diagram of a digital broadcast receiver according to an exemplary embodiment of the present invention.

Referring to FIG. 4, the digital broadcast receiver 220 may include a wireless communication unit 410, a storage unit 420, and a control unit 430. The storage unit 420 includes an SM bootloader zone 420A, and the control unit 430 includes an SM bootloader checker 430A and an SM bootloader register 430B.

The wireless communication unit 410 receives firmware from the digital broadcast transmitter 210 and forwards the received firmware to the control unit 430. When the wireless communication unit 410 uses radio frequency communication, it may include a radio frequency transmitter for upconverting the frequency of a signal to be transmitted and amplifying the signal, and a radio frequency receiver for low-noise amplifying a received signal and downconverting the frequency of the received signal.

The storage unit 420 stores programs and data necessary for an operation of the digital broadcast receiver 220, and may include a program area and a data area. More particularly, the storage unit 420 includes an SM bootloader zone 420A to store an SM bootloader that monitors the SM for downloading, update and deletion. When the digital broadcast receiver 220 is initially manufactured, an SM bootloader needs not be stored in the SM bootloader zone 420A. In this case, the digital broadcast receiver 220 has to download an SM bootloader from the digital broadcast transmitter 210 and register the downloaded SM bootloader.

The control unit 430 controls the overall operation of the digital broadcast receiver 220. When the digital broadcast receiver 220 functions as a DCAS host, it may descramble scrambled programs and data and perform authentication together with the digital broadcast transmitter 210 or other authentication servers. More particularly, the control unit 430 may decrypt the encrypted data zone of firmware received from the digital broadcast transmitter 210. The control unit 430 may verify an electronic signature attached to the received firmware through authentication.

The control unit 430 may include the SM bootloader checker 430A and the SM bootloader register 430B to install an SM bootloader.

The SM bootloader checker 430A detects presence of an SM bootloader in firmware received from the digital broadcast transmitter 210. In an exemplary implementation, an SM bootloader may be stored in a data zone of the firmware. When the SM bootloader is present in the received firmware, the SM bootloader checker 430A generates a signal indicating SM bootloader registration and outputs the signal to the SM bootloader register 430B.

The SM bootloader register 430B may reboot the digital broadcast receiver 220 in response to reception of a signal indicating SM bootloader registration. The SM bootloader register 430B extracts a new SM bootloader from the received firmware, and compares the new SM bootloader with the existing SM bootloader stored in the SM bootloader zone 420A. When the new SM bootloader is identical to the existing SM bootloader, the SM bootloader register 430B skips registration of the new SM bootloader. In this case, the digital broadcast receiver 220 operates by means of the existing SM bootloader.

When an SM bootloader is not stored in the SM bootloader zone 420A or the new SM bootloader is not identical to the existing SM bootloader, the SM bootloader register 430B registers the new SM bootloader in the SM bootloader zone 420A. In this case, the digital broadcast receiver 220 operates by means of the newly installed SM bootloader.

FIG. 6 is a flowchart illustrating a procedure performed by a digital broadcast transmitter according to an exemplary embodiment of the present invention.

Referring to FIG. 6, the digital broadcast transmitter 210 generates an SM bootloader to be registered in the digital broadcast receiver 220 in step S610. To ensure integrity, the digital broadcast transmitter 210 attaches an electronic signature to the generated SM bootloader in step S620. The digital broadcast transmitter 210 adds the SM bootloader to a data zone of firmware for the digital broadcast receiver 220, and encrypts the data zone of the firmware for data security in step S630.

Thereafter, the digital broadcast transmitter 210 transmits the firmware to the digital broadcast receiver 220 in step S640.

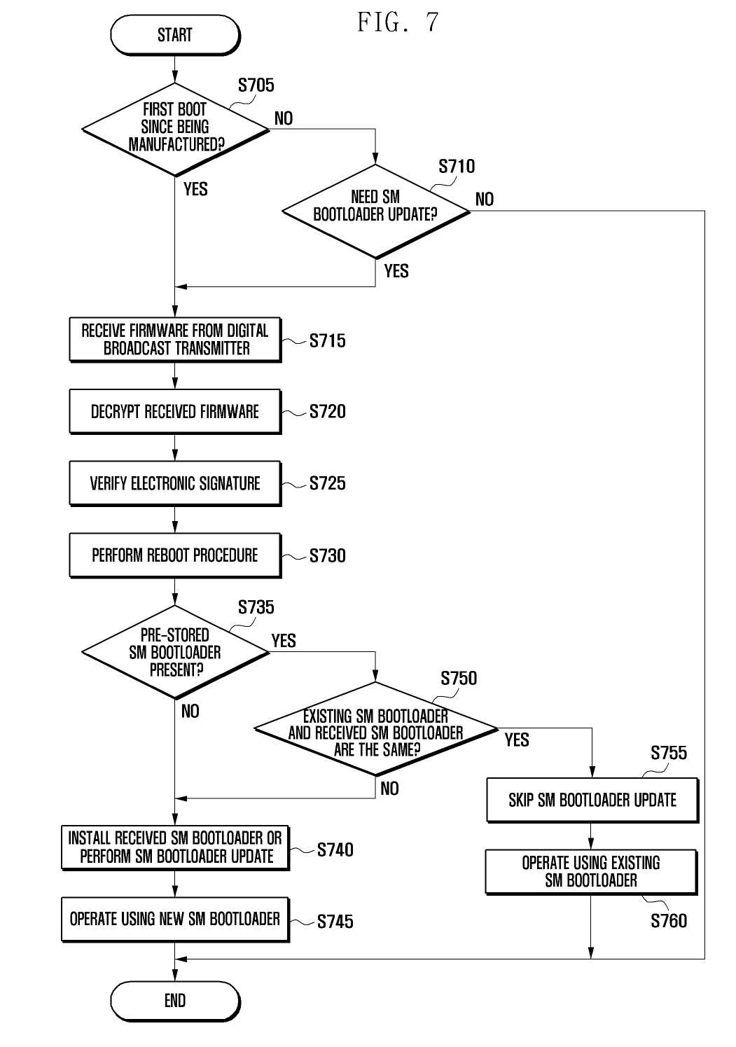

FIG. 7 is a flowchart illustrating a procedure performed by a digital broadcast receiver according to an exemplary embodiment of the present invention.

Referring to FIG. 7, when booting, the digital broadcast receiver 220 determines whether the booting is the first boot since being manufactured in step S705. If it is determined that the digital broadcast receiver 220 is booted for the first time, the digital broadcast receiver 220 proceeds to step S715 for installing an SM bootloader. When the digital broadcast receiver 220 is not booted for the first time, the digital broadcast receiver 220 determines in step S710 whether updating the installed SM bootloader is a necessity. The necessity for SM bootloader update may be determined by expiration of a preset time or reception of a signal for update from a digital broadcast transmitter 210.

If it is determined in step S710 that the digital broadcast receiver 220 is booted for the first time or the SM bootloader update is necessary, the digital broadcast receiver 220 receives firmware from the digital broadcast transmitter 210 in step S715. The digital broadcast receiver 220 decrypts the encrypted data zone of the received firmware in step S720. The digital broadcast receiver 220 verifies the electronic signature attached to the SM bootloader in the received firmware through authentication in step S725. The digital broadcast receiver 220 performs a reboot procedure in step S730.

After rebooting, the digital broadcast receiver 220 detects presence of an SM bootloader in the SM bootloader zone 420A of the storage unit 420 in step S735. When the digital broadcast receiver 220 is booted for the first time, the SM bootloader is not present in the SM bootloader zone 420A. When the SM bootloader is not present in the SM bootloader zone 420A, the digital broadcast receiver 220 installs the received SM bootloader in the SM bootloader zone 420A in step S740. Thereafter, the digital broadcast receiver 220 operates using the newly installed SM bootloader in step S745.

When an SM bootloader is present in the SM bootloader zone 420A in step S735, the digital broadcast receiver 220 compares a version identifier of the existing SM bootloader with that of the newly received SM bootloader in step S750. When the existing SM bootloader and the newly received SM bootloader are different versions, the digital broadcast receiver 220 performs the SM bootloader update by replacing the existing SM bootloader with the newly received SM bootloader in step S740. Thereafter, the digital broadcast receiver 220 operates using the newly received SM bootloader in step S745. When the existing SM bootloader and the newly received SM bootloader are the same version in step S750, the digital broadcast receiver 220 skips SM bootloader update in step S755 and the digital broadcast receiver 220 operates using the existing SM bootloader in step S760.

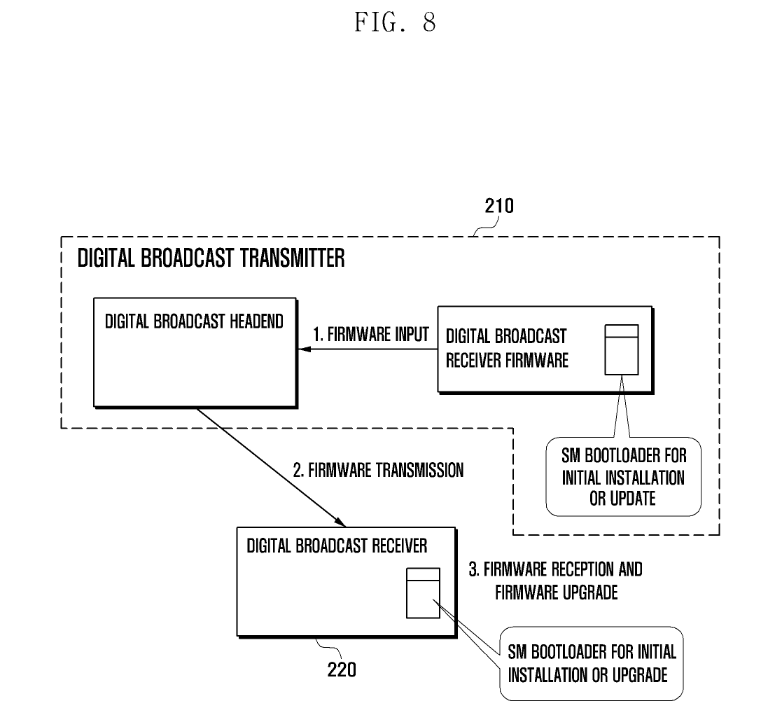

FIG. 8 depicts an online procedure for a digital broadcast receiver to download an SM bootloader from a digital broadcast transmitter and to register the same according to an exemplary embodiment of the present invention.

Referring to FIG. 8, the digital broadcast transmitter 210 adds an SM bootloader to firmware for the digital broadcast receiver 220, and transmits the firmware containing the SM bootloader to the digital broadcast receiver 220. The digital broadcast receiver 220 receives the firmware, locates an SM bootloader in the firmware, and registers the located SM bootloader.

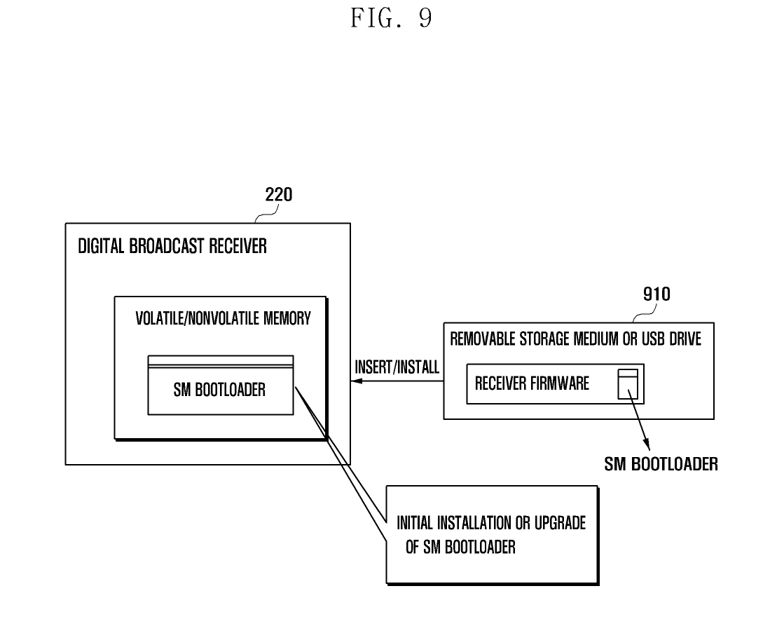

FIG. 9 depicts an offline procedure for a digital broadcast receiver 220 to download and register an SM bootloader according to an exemplary embodiment of the present invention.

As described above, the digital broadcast receiver 220 may download an SM bootloader through an offline procedure instead of an online procedure.

Referring to FIG. 9, for the offline procedure, firmware containing the SM bootloader may be stored in a removable storage medium such as a USB flash drive 910. When the removable storage medium is connected through a corresponding interface to the digital broadcast receiver 220, the firmware containing the SM bootloader may be transferred to the digital broadcast receiver 220 and the SM bootloader may be installed.

As apparent from the above description, the digital broadcast receiver 220 in the DCAS may download or install an SM bootloader online or offline.

While the invention has been shown and described with reference to certain exemplary embodiments thereof, it will be understood by those skilled in the art that various changes in form and detail may be made therein without departing from the spirit and scope of the invention as defined by the appended claims and their equivalents.

What is claimed is:

1. A method for downloading a Secure Micro (SM) bootloader for a receiver in a Downloadable Conditional Access System (DCAS), the method comprising:
generating, by a transmitter, an SM bootloader for the receiver and adding the generated SM bootloader to firmware to be transferred to the receiver;
transmitting, by the transmitter, the firmware to the receiver; and
performing, by the receiver, registration by receiving the firmware, locating an SM bootloader in the firmware, and registering the located SM bootloader.

2. The method of claim 1, wherein the generating of the SM bootloader further comprises:
attaching an electronic signature to the SM bootloader for the receiver.

3. The method of claim 1, wherein the generating of the SM bootloader further comprises:
encrypting a data zone of the firmware containing the SM bootloader.

4. The method of claim 1, wherein the performing of the registration further comprises:
determining a presence of a pre-stored SM bootloader in the receiver; and
installing, when a pre-stored SM bootloader is not present, by the receiver, the located SM bootloader.

5. The method of claim 4, wherein the performing of the registration further comprises:
comparing, when a pre-stored SM bootloader is present, a version identifier of the pre-stored SM bootloader with the version identifier of the located SM bootloader; and
conducting, when the pre-stored SM bootloader and the located SM bootloader are different versions, an SM bootloader update by replacing the pre-stored SM bootloader with the located SM bootloader.

6. An apparatus for downloading a Secure Micro (SM) bootloader for a receiver from a transmitter in a Downloadable Conditional Access System (DCAS), the apparatus comprising:
a wireless communication unit for receiving firmware from the transmitter;
a control unit for determining presence of an SM bootloader in the received firmware and for registering, when an SM bootloader is located, the located SM bootloader; and
a storage unit for storing the registered SM bootloader.

7. The apparatus of claim 6, wherein the firmware comprises a code execution zone and a data zone, and the SM bootloader is embedded in the data zone.

8. The apparatus of claim 7, wherein the control unit decrypts, when the data zone of the firmware is encrypted, the data zone of the firmware.

9. The apparatus of claim 7, wherein the control unit verifies, when an electronic signature is attached to the SM bootloader in the data zone, the attached electronic signature.

10. The apparatus of claim 6, wherein the control unit, upon reception of an SM bootloader from the transmitter, detects presence of a pre-stored SM bootloader in the storage unit, and installs, when the pre-stored SM bootloader is not present, the received SM bootloader.

11. The apparatus of claim 10, wherein the control unit compares, when the pre-stored SM bootloader is present, a version identifier of the pre-stored SM bootloader with the version identifier of the received SM bootloader, and conducts, when the pre-stored SM bootloader and the received SM bootloader are different versions, SM bootloader update by replacing the pre-stored SM bootloader with the received SM bootloader.

12. A system for downloading a Secure Micro (SM) bootloader in a Downloadable Conditional Access System (DCAS), the system comprising:
a transmitter for generating an SM bootloader, for adding the generated SM bootloader to firmware to be transferred, and for transmitting the firmware; and
a receiver for receiving the firmware from the transmitter, for locating the SM bootloader in the received firmware, and for registering the located SM bootloader.

13. The system of claim 12, wherein the firmware is received from the transmitter when at least one of the receiver is booted for a first time and the SM bootloader update is necessary.

14. The system of claim 13, wherein the receiver decrypts an encrypted data zone of the received firmware.

15. The system of claim 14, wherein the receiver verifies an electronic signature attached to the SM bootloader in the received firmware through authentication.

16. The system of claim 15, wherein the receiver performs a reboot procedure and detects presence of an SM bootloader in a storage unit.

17. The system of claim 16, wherein the receiver compares a version identifier of an existing SM bootloader with a newly received SM bootloader.

18. The system of claim 17, wherein the receiver performs an SM bootloader update, if the existing SM bootloader and the newly received SM bootloader are different versions.

19. The system of claim 18, wherein the receiver operates using the existing bootloader, if the existing SM bootloader and the newly received bootloader are the same version.
